(19) United States
(12) Patent Application Publication
(10) Pub. No.: US 2002/0015751 A1
(43) Pub. Date: Feb. 7, 2002

(54) Calender device

(76) Inventor: Ake Rosen, Rydeback (SE)

Correspondence Address: BIRCH STEWART KOLASCH & BIRCH, PO BOX 747, FALLS CHURCH, VA, 22040-0747, US

(21) Appl. No.: 09/737,967

(22) Filed: Dec. 18, 2000

Related U.S. Application Data
(63) Continuation of application No. PCT/SE99/01142, filed on Jun. 24, 1999.

(30) Foreign Application Priority Data
Jun. 26, 1998 (SE) 980280-9

(51) Int. Cl. B29C 53/00

(52) U.S. Cl. 425/325; 425/327; 425/363

(57) ABSTRACT

A calendar device for rolling an extruded plastic material comprises at least two elongate rolls, which are arranged essentially in parallel to form the extruded material into a web-shaped material. One of the rolls is a cooling roll, which at least partially is immersed in a cooling bath to cool the roll together with the rolled material when abutting against the cooling roll.

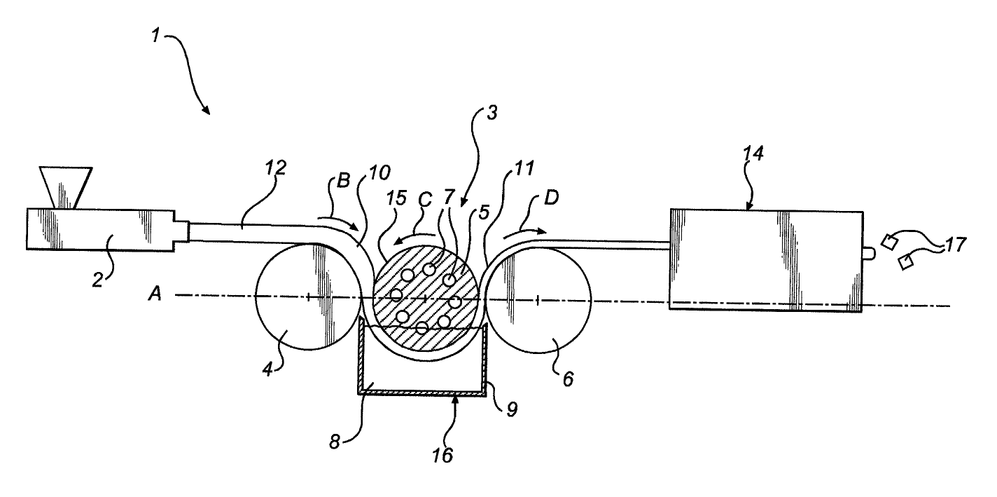

### FIELD OF THE INVENTION

The present invention relates to a calender device of the type stated in the preamble to appended claim 1. The invention further relates to a device for extruding and forming a web-shaped plastic material, comprising such a calender device.

### BACKGROUND ART

Calendering has been used for a long time to form extruded plastic material into a film-, foil- or web-shaped material. As a rule, the rolls are successively arranged in the vertical direction or, in combination, vertically and horizontally at an angle. Prior-art arrangements of rolls are in the form of an I, L, an inverted L and a Z.

In the manufacture of plastics, it is common to have 3- or 4-roll calenders, in which the rolls are arranged vertically above each other. The extruded plastic web is first introduced between a first and a second roll and is then passed on along the rolls and through the different nips forming therebetween. It is desirable to lower the temperature of the initially very hot plastic material during the forming into a completed web. At least one of the rolls therefore is a cooling roll, usually the second roll, and has through cooling ducts for a cooling agent for lowering the temperature of the plastic material.

In different contexts, high demands are placed on this cooling. For instance, the cooling effect is a limiting factor to the feeding rate of the plastic material web and, thus, to the production rate.

With a view to achieving a good cooling effect, the cooling ducts are nowadays usually arranged close to the circumferential surface of the cooling roll. A common distance (thickness of material) between the cooling duct and the circumferential surface is about 5 mm. This is close to a critical limit, at which the circumferential surface tends to be deformed inwardly, to “yield”, when exposed to high radial forces, i.e. a high nip pressure, in the roll nips. The nip pressure is approximately proportionally dependent on the feeding rate of the web, and thus also the deformation or deficient dimensional stability of the circumferential surface is a limiting factor to the feeding rate. Moreover, the deficient dimensional stability is a particular problem in the manufacture of thin webs, which require high nip pressures between the rolls. If the cooling roll is not dimensionally stable and tends to be deformed, this results in an inferior quality of the plastic material, for instance, depending on variations in thickness and deficient homogeneity of the material.

### SUMMARY OF THE INVENTION

In view of the above prior-art, an object of the present invention is to provide improvements in cooling in connection with calendering of an extruded plastic material.

A special object is to obviate or reduce the problem of deformation of the circumferential surface of the cooling rolls when subjected to pressure.

A further object is to provide improvements which enable a higher production rate when manufacturing a web-shaped plastic material.

According to the invention, these and other objects that will appear from the following description are now achieved by a calender device which is of the type described by way of introduction and which in addition has the features stated in the characterising clause of claim 1. The objects are also achieved by a device for extruding and forming a web-shaped plastic material according to claim 4.

Thus, the calender device comprises at least two elongate rolls, which are arranged essentially in parallel to form the extruded material into a web-shaped material, and a cooling roll which at least partially is immersed in a cooling bath to cool the roll together with the rolled material when abutting against the cooling roll, said calender device being characterised in that the cooling roll is arranged between at least two rolls to provide at least two intermediate nips for forming the web-shaped material and abutment of the material against the cooling roll between the two nips, and that the cooling roll and the two surrounding rolls are successively arranged along an essentially horizontal line, the cooling roll being the only roll which is immersed in the cooling bath.

As a result, a device in which the cooling roll is cooled from outside is provided. It will thus be easier to freely dimension the cooling capacity with the aid of the cooling bath. The demands placed on internal cooling ducts in the cooling roll are lowered, and it will even be possible, in some cases, to completely leave out internal ducts. The plastic material is in the first place cooled directly by the cooling agent in the cooling bath and, only in the second place, by the cooling roll, thereby achieving a more efficient cooling. It has been found .in experiments that the production rate could be more than doubled thanks to the improved cooling. Moreover it is ensured that the manufactured material has uniform properties over its entire surface.

Thanks to the cooling roll being arranged between at least two rolls in order to provide at least two nips for forming the web-shaped material and abutment of the rolled material against the cooling roll between the two nips, a compact calender device is provided, which allows simultaneous forming in the roll nips and cooling adjacent to the intermediate cooling roll.

The invention has been found advantageous when manufacturing thermoplastics and in particular when manufacturing materials comprising a polyolefin with an admixed filling material of mineral, such as chalk.

Preferred embodiments are defined in the dependent claims.

In an advantageous embodiment, the cooling roll is formed with internal cooling ducts for a higher cooling capacity. This results in cooling of the plastic material from two sides and, thus, also uniform cooling. The cooling ducts can be located at a sufficiently great distance from the roll periphery for the circumferential surface of the roll to maintain its curvature also at high radial pressures. It is preferred for the distance (thickness of material) between cooling duct and circumferential surface of the cooling roll to be in the range 7-15 mm. Particularly good results are achieved at about 10 mm.

### BRIEF DESCRIPTION OF THE DRAWINGS

The invention will now be described in more detail with reference to the accompanying Figure, which for the purpose of exemplification illustrates a currently preferred embodiment of the present invention.

The Figure shows schematically and partially in section a device for extruding and forming a web-shaped plastic material according to the invention.

### DESCRIPTION OF PREFERRED EMBODIMENTS

The device 1 shown in the Figure for extruding and forming a web-shaped plastic material comprises an extruder 2 of a conventional type, a calender device generally designated 3, and a forming station 14. Also a plastic material 12 is shown, which is extruded from the extruder 2, is given a uniform web shape with a predetermined thickness in the calender device 3 and is formed into finished products at the forming station 14.

The calender device 3 comprises a first roll 4, a second roll 5, which also is the cooling roll, and a third roll 6, which are successively arranged along an essentially horizontal line A. The rolls 4-6 are supported by a common roll frame (not shown), which has means for holding the rolls pressed against each other while maintaining predetermined nip dimensions. Between first and the second roll 4, 5 there is a first nip 10, and between the second and the third roll 5, 6 there is a second nip 11. The two nips 10, 11 successively reduce the thickness of the web 12. The final thickness is controlled by the second nip 11. In the described field of application, the nip dimensions are typically in the range 0.02 mm-1 mm. The directions of rotation of the rolls 4-6 are indicated by arrows B-D.

The cooling roll 5, which is shown in cross-section, comprises a number of cooling ducts 7 extending axially through the roll 5 and is immersed in a cooling bath 16 containing a cooling liquid 8, for instance water, in a cooling trough 9. A control system (not shown) can be arranged to control the temperature of the cooling liquid. Thanks to the invention, lower demands are placed on the ducts of the cooling roll, which can be fewer and more centrally arranged in the roll. In the preferred embodiment, the cooling ducts are arranged at a distance of about 10 mm radially from the circumferential surface 15 of the cooling roll.

The forming station 14 may consist of an optional device for vacuum forming, blow moulding or the like to form finished products, such as packages 17, in line. In alternative embodiments, the forming station can be replaced by a wind-up station, in which case the web, when necessary, can be processed at a later stage in some other place.

Using a device of the type described above, essential improvements in the cooling effect of the calender device have been achieved. In experiments involving manufacture of a web of polyolefin material with a filler of mineral material in a device which has previously been capable of producing a web at a speed of 15-25 m/min. in a conventional calender device, a calender device according to the invention has made it possible to increase the production rate to 30-60 m/min. The experiments relate to plastic material having a thickness of about 0.4 mm.

An important advantage of the shown embodiment is that the lower circumferential portion of the cooling roll is arranged at the same level as or lower than the lower peripheral portions of the two surrounding rolls, which gives great liberty in designing and placing the cooling trough.

The invention is not limited to the above embodiment and a number of modifications are feasible within the scope of the appended claims. For instance, the calender device may comprise more than one cooling roll.

1. A calender device for rolling an extruded plastic material, comprising at least two elongate rolls (4-6),
which are arranged essentially in parallel to form the extruded material (12) into a web-shaped material, and
a cooling roll (5), which at least partially is immersed in a cooling bath (16) for cooling the roll (5) together with the rolled material (12) when abutting against the cooling roll (5), characterised in that
the cooling roll (5) is arranged between at least two rolls (4, 6) to provide at least two intermediate nips (10, 11) for forming the web-shaped material (12) and abutment of the material (12) against the cooling roll (5) between the two nips (10, 11), and
the cooling roll (5) and the two surrounding rolls (4, 6) are successively arranged along an essentially horizontal line (A), the cooling roll (5) being the only roll which is immersed in the cooling bath (8).

2. A calender device as claimed in claim 1, wherein the cooling roll (5) has a number of cooling ducts (7) extending through the roll.

3. A calender device as claimed in claim 2, wherein the cooling ducts (7) of the cooling roll (5) are arranged at a distance of at least 7 mm, preferably at least 10 mm, from the circumferential surface of the roll (5).

4. A device for extruding and forming a web-shaped plastic material, characterised by a calender device (3) according to any one of claims 1-3, which is arranged after an extruder (2).

5. A device as claimed in claim 4, wherein a forming station (14) is arranged after the calender device (3) for processing the web-shaped material (12) into products.
